(19) United States
(12) Patent Application Publication
(10) Pub. No.: US 2026/0204858 A1
(43) Pub. Date: Jul. 16, 2026

(54) Soldering, Sealing and Strain Relief For Flat Flexible Cables

(71) Applicant: TE Connectivity Solutions GmbH, Schaffhausen (CH)

(72) Inventor: Christopher Ryan Raybold, Middletown, PA (US)

(73) Assignee: TE Connectivity Solutions GmbH, Schaffhausen (CH)

(21) Appl. No.: 19/184,217

(22) Filed: Apr. 21, 2025

Related U.S. Application Data
(60) Provisional application No. 63/745,957, filed on Jan. 16, 2025.

(51) Int. Cl. H01R 43/02; H01R 12/77

(52) U.S. Cl. CPC H01R 43/0256; H01R 12/771

(57) ABSTRACT

A method of attaching a flat flexible cable (FFC) to a plurality of terminals is provided. The method includes arranging a plurality of terminals within a connector housing, each terminal defining a weld area adapted to be electrically connected to a conductor of the FFC. The FFC is positioned proximate the connector housing such that the weld area of each terminal is arranged directly adjacent a respective one of a plurality of exposed conductors of the FFC. A cable latch is fitted to the connector, the cable latch including an adhesive hot melt material applied thereon. The weld areas of the terminals are clamped against the exposed conductors of the FFC with the cable latch. Finally, the weld area of each of the plurality of terminals is heated with an inductive heating source for electrically connecting the plurality of conductors of the FFC to the plurality of terminals and melting the adhesive hot melt material.

### CROSS-REFERENCE TO RELATED APPLICATION

This application claims the benefit of U.S. Provisional Patent Application No. 63/745,957, filed on Jan. 16, 2025, whole disclosure of which is incorporated herein by reference.

### FIELD OF THE INVENTION

The present disclosure relates to electrical connectors, and more particularly, to systems and methods for electrically connecting flat flexible cables to conductive terminals of electrical connectors.

### BACKGROUND

As understood by those skilled in the art, flat flexible cables (FFCs) or printed flexible cables (PFCs) are electrical components consisting of at least one conductor (e.g., a metallic foil conductor) embedded within a thin, flexible strip of insulation. Flat flexible cables are gaining popularity across many industries due to advantages provided over their traditional “round wire” counter parts. Specifically, in addition to having a lower profile and lighter weight, FFCs enable the implementation of large circuit pathways with significantly greater ease, and utilizing substantially less space or volume, compared to a round wire-based architectures. As a result, FFCs are being implemented into many complex and/or high-volume applications, including wiring harnesses such as those used in automotive manufacturing.

A critical obstacle preventing the implementation of FFCs into these applications includes the need to develop quick, robust, and low resistance termination techniques which enable the FFCs to be mating with various components, including existing terminal systems and headers. One particular challenge includes reliably and efficiently terminating the fragile conductors of the FFC to a conductive terminal of a connector. Existing methods include the use of laser or resistance heating techniques. Laser heating, however, is often less reliable and cumbersome to implement. Likewise, resistance heating has proven relatively difficult to reliably implement, further it is time consuming and requires regular maintenance (e.g., the replacement of heating tips). Current methods are also not suitable for mass termination and/or automation, which the industry desires.

Accordingly, improved systems and methods for terminating FFC assemblies are desired.

### SUMMARY

In one embodiment of the present disclosure, a method of attaching a flat flexible cable (FFC) to a plurality of terminals is provided. The method includes arranging a plurality of terminals within a connector housing, each terminal defining a weld area adapted to be electrically connected to a conductor of the FFC. The FFC is positioned proximate the connector housing such that the weld area of each terminal is arranged directly adjacent a respective one of a plurality of exposed conductors of the FFC. A cable latch is fitted to the connector, the cable latch including an adhesive hot melt material applied thereon. The weld areas of the terminals are clamped against the exposed conductors of the FFC with the cable latch. Finally, the weld area of each of the plurality of terminals is heated with an inductive heating source for electrically connecting the plurality of conductors of the FFC to the plurality of terminals and melting the adhesive hot melt material.

### BRIEF DESCRIPTION OF THE DRAWINGS

The invention will now be described by way of example with reference to the accompanying Figures, of which:

FIG. 1 is front perspective view of an FFC connector assembly and FFCs useful for describing embodiments of the present disclosure in a mated state;

FIG. 2 is a top (or bottom) perspective view of an exemplary FFC useful for describing embodiments of the present disclosure;

FIG. 3 is a top perspective view of a plug of the connector assembly of FIG. 1;

FIG. 4 is a side perspective view of the plug of FIG. 3;

FIG. 5 is a side perspective view of a terminal used in the connector assembly and plug of the preceding figures;

FIG. 6 is a rear, bottom perspective view of a cable latch or stiffening element of the connector assembly of FIG. 1;

FIG. 7 is a partially exploded view of the plug and cable latches of the connector assembly of FIG. 1;

FIG. 8 is a perspective view of the connector assembly of the preceding figures in an initial or shipping position prior to the insertion and/or connection of one or more FFCs.

FIG. 9 is a front view of the connector assembly of FIG. 8 with a pair of FFC received therein, prior to a soldering or connection/termination step;

FIG. 10 is a process diagram illustrating an exemplary cable/connector assembly method according to an embodiment of the present disclosure; and

FIG. 11 is a diagram of an exemplary system useful for performing the soldering operations described herein.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

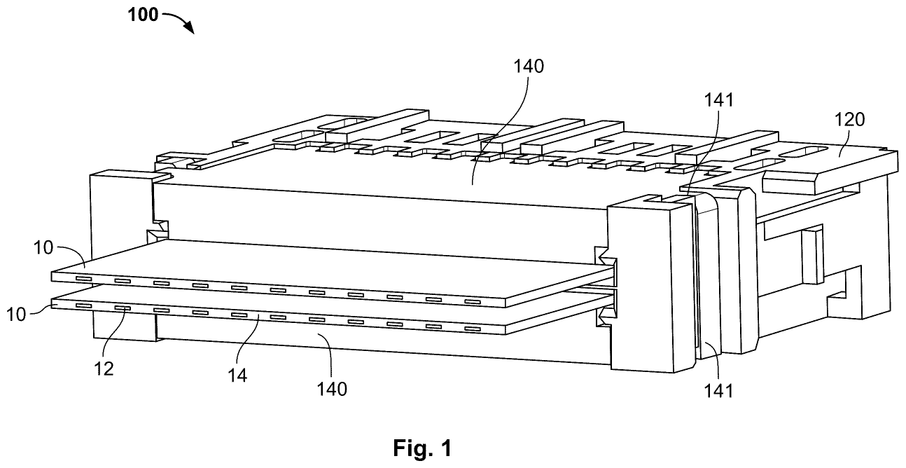

Referring to FIG. 1, an exemplary FFC connector assembly 100 according to embodiments of the present disclosure is shown. The connector assembly 100 includes a plug or plug housing 120 adapted to receive one or more flat flexible cables (FFCs) 10, in this embodiment two FFCs 10, and a corresponding one or more (i.e., two) cable latches or stiffening elements 140. Each of the cable latches 140 includes a pair of latch arms 141 on its lateral sides which selectively engage with corresponding catches formed on the sides of the plug 120 for securing the cable latches 140 in one of a plurality of positions on the plug 120. The assembly 100 is adapted to electrically connect the FFC(s) 10 to another element, such as a mating plug, for example a header operatively connected to a substrate (e.g. a printed circuit board or PCB).

As will be set forth in greater detail herein, FIG. 1 illustrates the connector assembly 100 in a final assembled state, either just before or after heating. Specifically, the cable latches 140 are engaged with the FFCs 10 and the plug 120 in a closed or second position. The conductors 12 of the FFCs 10 are, or are in position to be, soldered to terminals housed within the plug 120 via termination methods according to embodiments of the present disclosure.

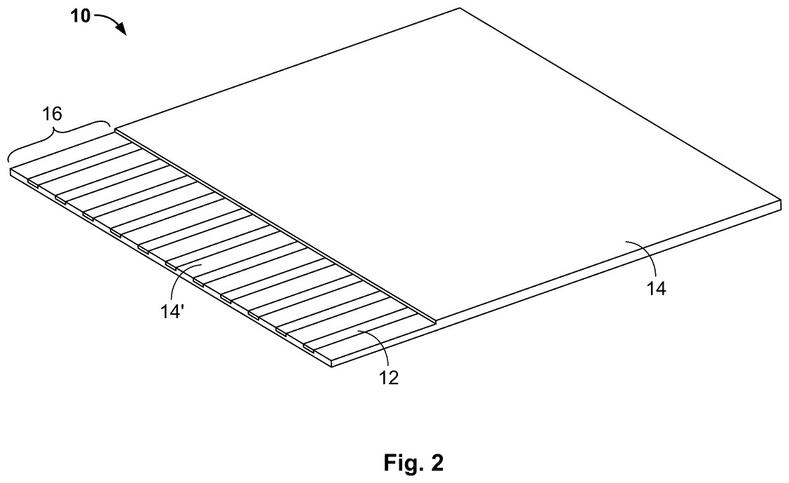

Referring to FIG. 2, the exemplary FFC 10 useful for describing embodiments of the present disclosure includes the conductors 12 embedded within the insulating material 14. The conductors 12 may comprise metallic sheet or foil, such as copper foil, by way of example only, patterned in any desirable configuration. The insulating material 14, such as a polymer insulating material, may be applied to either side of the conductors 12 via an adhesive, resulting in an embedded conductor arrangement. In a preferred embodiment, the insulating material 14 is extruded. The insulating material 14 may be selectively removed, or not initially applied, in desired areas for exposing the conductors 12, such as in a window 16 defined on an underside (or topside) of the exemplary illustrated FFC 10. In one embodiment, the window 16 may include an entire underside or bottom layer of the insulating material 14, thus leaving the conductors 12 generally coplanar with, or raised slightly above, a remainder of the insulating material 14′ positioned between adjacent conductors. The exposed portion of each of the conductors 12 is then connected (e.g., soldered) to a respective terminal held within the plug 140, as will be set forth in greater detail herein.

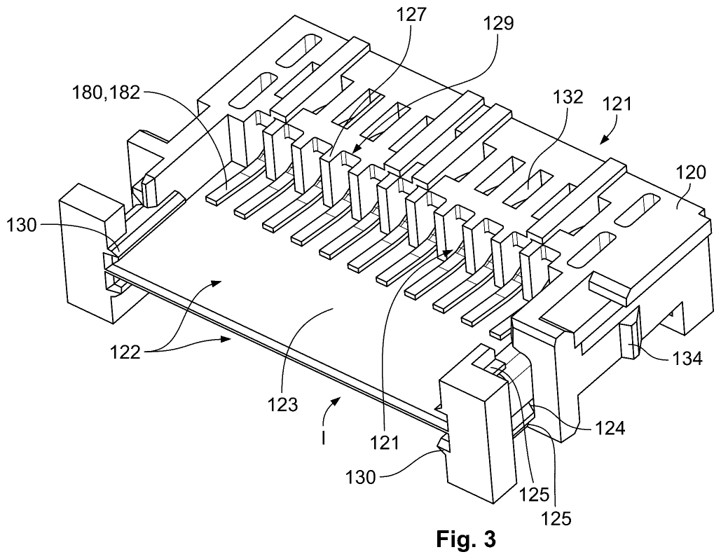

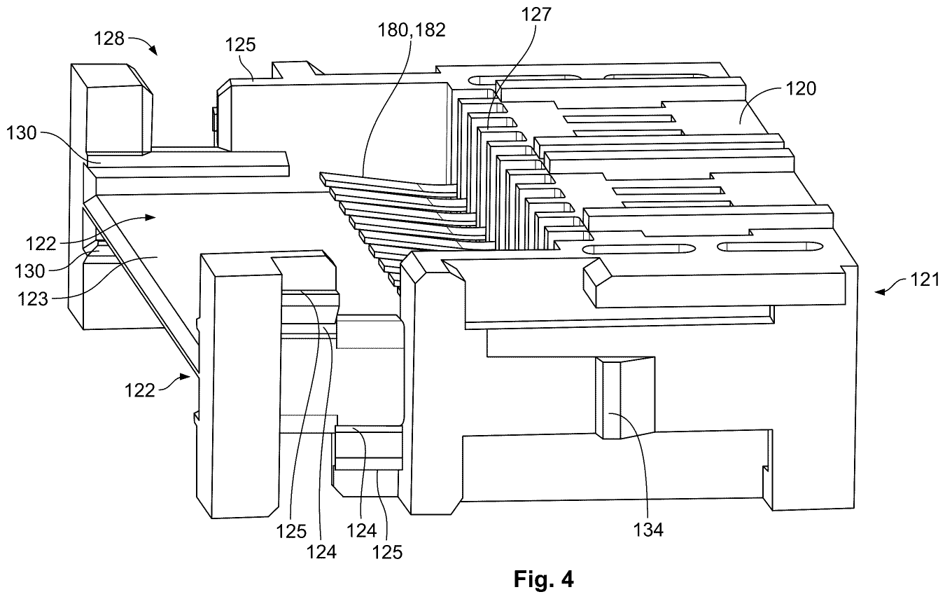

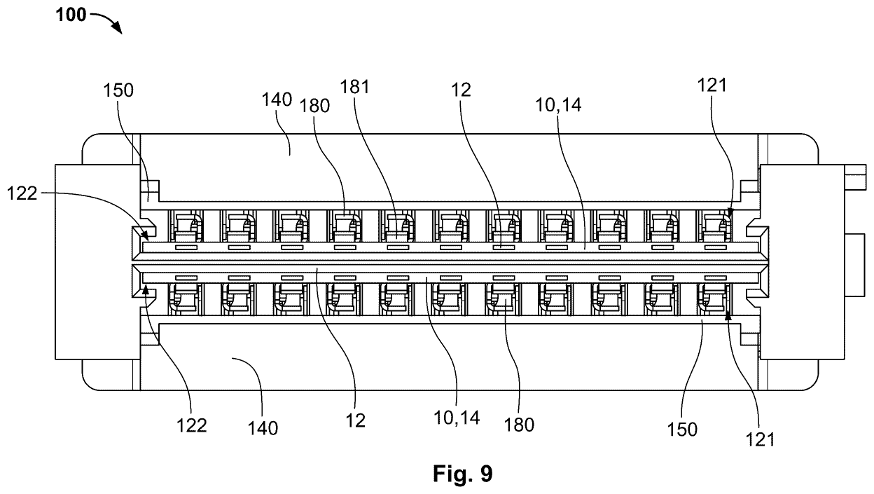

Referring now to FIGS. 3 and 4, the connector assembly 100 is shown with the cable latches 140 removed therefrom. The plug or plug body 120 includes a plurality of terminal openings 121 (see FIG. 9) into which a first row of a plurality of conductive terminals 180 are held. Flattened weld ends 182 of each of the terminals extend into an upper portion of a cable receiving space 122 defined in the plug 120, and define downwardly facing weld areas or surfaces. It should be understood that a second row of the terminals 180 are also arranged in a lower portion of the cable receiving space 122 in a manner similar to the illustrated first row of terminals 180 (see FIG. 9), and define upwardly facing weld areas or surfaces. In the exemplary plug 120, a generally planar partition wall 123 separates the cable receiving space 122 into the upper and lower portions, with each portion adapted to receive a respective one of the two FFCs 10 therein in an insertion direction I, as well as a respective one of the cable latches 140.

As is most clearly shown in FIG. 4, a guide protrusion 130 extends along each side of each of the upper and lower portions of the cable receiving space 122 for guiding each of the FFCs 10 into position beneath each of the terminals 180. Specifically, each of the weld ends 182 of the terminals 180 are bent in a direction away from the partition wall 123 such that each of the FFCs 10 may be received between the partition wall 123 and the weld ends of the terminals. In this way, the weld surfaces of the weld ends 182 which oppose the partition wall 123 will oppose the FFCs 10 (and more specifically, the exposed conductors 12 thereof) inserted into the cable receiving space.

The plug 120 further defines a plurality of pairs of catches 124, 125 defined on each exterior lateral side thereof. As will be set forth in greater detail therein, each pair of catches 124, 125 defines a latching position of the cable latch 140 on the plug 120, with the catches 124 corresponding to an initial open or first position of a respective one of the cable latches 140 relative to the plug 120, and the catches 125 corresponding to the closed or second position, of the respective cable latch 140 relative to the plug. In the exemplary embodiment, each of the catches 124, 125 are arranged in lateral channels 128 defined in the plug 120. As shown, the location of the catches 124, 125 are mirrored on each lateral side of the plug 140, such that the cable latches 140 may be identical to one another, simplifying manufacturing. Cantilevered elastic latches 134 may be formed on either side of the plug 120 for engaging with a corresponding mating connector into which the plug is adapted to be inserted or mated to.

The plug 120 further defines a plurality of vertical partitioning walls 127 extending into each of the upper and lower portions of the cable receiving space 122. The partitioning walls 127 separate each of the adjacent terminals 180, and define corresponding slotted openings 129 therebetween adapted to receive corresponding protruding, finger-like features of the cable latches 140. Terminal latch openings 132 are in communication with each of the terminal openings 121, and are adapted to receive and/or engage with a corresponding terminal latch of each terminal 180 for securing the terminal within the terminal opening. In the exemplary embodiment, the plug or plug housing 120 may be formed of an insulating polymer material, such as polybutylene terephthalate (PBT), nylon, or the like.

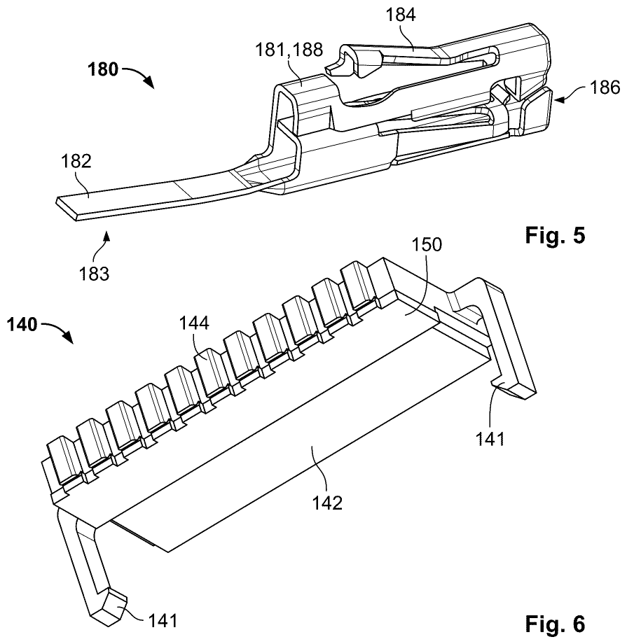

A detailed view of the exemplary conductive terminal 180 according to embodiments of the present disclosure is illustrated in FIG. 5. The exemplary terminal 180 has a body 181 defining a female mating end or opening 186 adapted to receive, for example, a conductive male mating terminal (e.g., a pin terminal) therein. The terminal body 181 further defines an elastic termina latch 184 (i.e., a cantilevered arm) adapted to engage with the terminal catch opening 132 of the plug 120 for fixing the terminal 180 with the terminal opening 121 of the plug. A mechanical stop 188 is further defined by the terminal body 181 for setting an insertion depth of the terminal 180 into the terminal opening 121 in the insertion direction I.

The weld end 182 of the terminal 180 defines a weld area or surface 183 on an underside thereof adapted to be electrically connected to the exposed conductor 12 of the FFC 10 via welding or soldering. As shown the weld end 182 is inclined, or curves radially upward in the orientation shown, such that when the terminal 180 is installed into the plug, a gap is created between the weld surface and the partition wall 123 for receiving the FFC 10.

As can be visualized from the figures, the terminal 180 may be formed by a combination of sheet metal forming operations, such as stamping and bending. Additional stamping may be utilized to flatten the weld end 182 to a sufficiently wide and uniformly flat surface optimized for soldering to the FFC. The weld end 182, and in particular the weld area 183, may be tinned with solder, with flux applied thereover prior to installation within the plug 120.

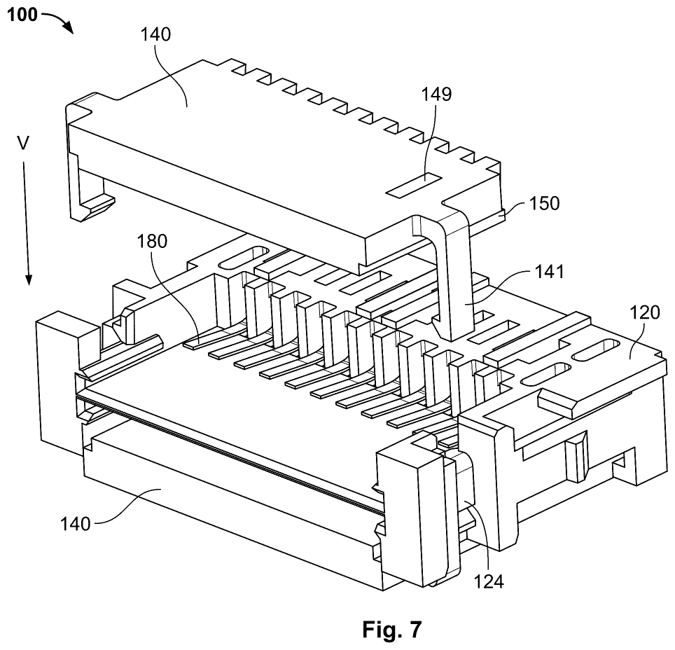

Referring now to FIG. 6, the cable latch 140 is shown in greater detail. The cable latch 140 includes a body defining the latches or latch arms 141 extending therefrom and adapted to engage with the plug 140 in the plurality of positions as described above. An underside 142 of the cable latch 140 is generally planar, and is adapted to abuttingly oppose the FFC installed within the plug 140 and/or the weld ends 182 of each of the terminals 180. The cable latch 140 further defines a plurality of alignment protrusions or fingers 144 adapted to be received within respective ones of the slotted openings 129 defined by the partitioning walls 127 of the plug 120. In this way, the orientation and alignment of the cable latch 140 is maintained as it is received by/engaged with the plug 120, and more particularly, as it is moved between the first and second positions. As shown in FIG. 7, the cable latches 140 may also include weld windows 149 (one exemplary window illustrated) formed therethrough in order to facilitate welding or soldering of the FFC 10 and the terminals 180 from a top side of the cable assembly 100.

Adhesive hotmelt 150 is applied on the underside 142 of the cable latch 140, including on the alignment protrusions 144. As will be set forth in greater detail herein, the hotmelt 150 is selected or adapted to be melted during soldering of the terminals 180 to the FFCs 10, such that the hotmelt flows around the terminal ends 182 and the conductors 12 of the FFCs. This encapsulation of the solder joints may prevent galvanic corrosion between the conductors 12 (e.g., aluminum foil conductors) and the terminals 180, provides additional sealing of the connector space relative to the external environment and strain relief, and improves the pull out strength of the FFC 10. Further, the adhesive hotmelt 150 may bond with the cable latch 140 and/or the plug 140, further strengthening the connector assembly 100. As with the plug 120, the cable latch 140 may also be formed of an insulating polymer material, such as polybutylene terephthalate (PBT), nylon, or the like. The hotmelt 150 may be selected to be compatible with (e.g., bond with) the materials used to form plug 120 and/or the cable latch 140, as well as with the insulation material 14 of the FFCs 10.

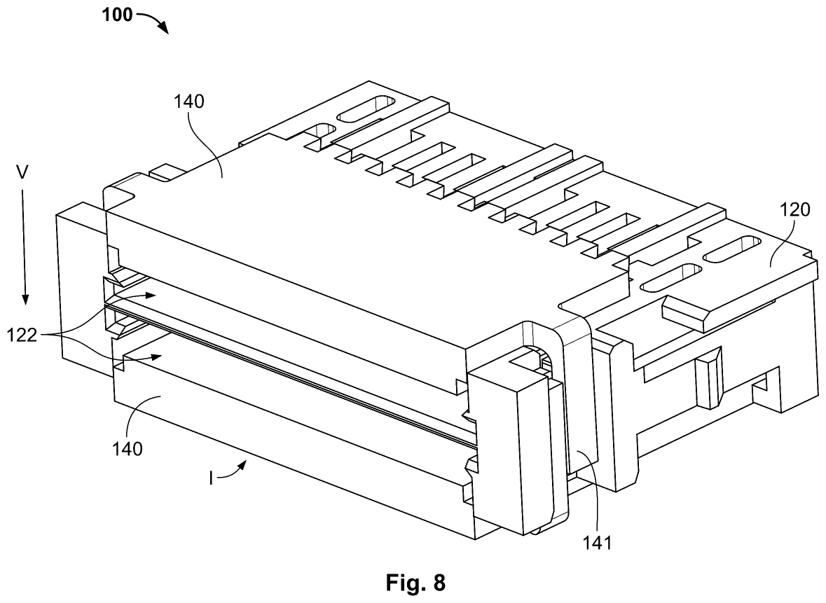

FIG. 7 illustrates the connector assembly 100 with one of the cable latches 140 engaged with the plug 120 in the first position, and a second one of the cable latches 140 being installed onto the plug. More specifically, the cable latch 140 is inserted onto the plug in the downward vertical direction V such that latch arms 141 thereof engage with the first position catches 124. As shown, the adhesive hot melt 150 is oriented above the weld ends 181 of the terminals 180. FIG. 8 shows the connector assembly 100 in the first state or open state, and ready to receive the FFCs 10 therein. Specifically, each of the cable latches 140 is arranged in the first position, forming the upper and lower portions of the cable space 122. In this open position, the FFCs 10 may be inserted into the plug 120 in the insertion direction I, and beneath the weld ends 181 of the terminals 180. This is shown in FIG. 9, wherein the FFCs 10 have been inserted into the cable space 122. Note, the conductors 12 of each FFC 10 are aligned with a respective one of the terminals 180 in the vertical directions. The adhesive hotmelt 150 is held above (i.e., separated vertically from) the top sides of the weld ends 181 of the terminals. After the FFCs 10 have been inserted, and the connector assembly 100 is prepared for soldering, each of the cable latches 140 is moved into the second or closed position, biasing the weld areas 181 of the terminals 180 toward the partitioning wall 123, and clamping the FFCs 10 therebetween. Specifically, the cable latches 140 bias the weld ends 181 of the terminals into abutting contact with the conductors 12 of the FFCs 10. This second or closed position is shown in FIG. 1, wherein the latch arms 141 of the cable latches 140 have engaged with the second catches 125 of the plug 120. In this position, compression of the weld ends 181 of the terminals 180 onto the FFCs is maintained.

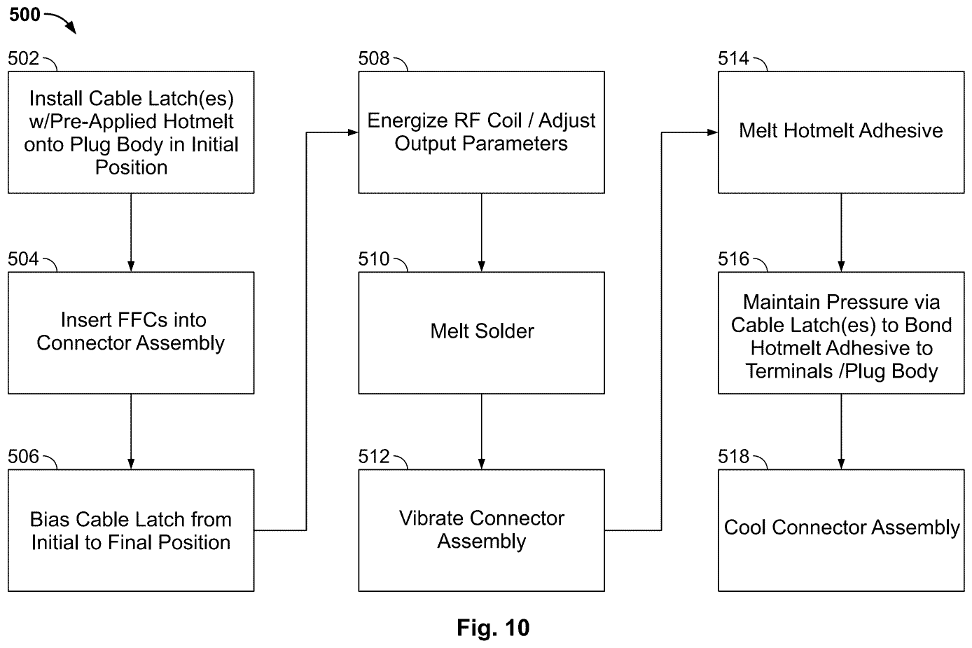

Referring now to FIG. 10, an exemplary terminating method 500 of one or more FFCs according to embodiments of the present disclosure is summarized. In a first step 502, the cable latches having the adhesive hotmelt 150 pre-applied thereto are fitted to the plug housing 120 (into which the terminals 180 have been installed) in the first or initial position. This may constitute a shipping position, wherein the connector assembly 100 has been prepared for final terminalization by an end user at another location. At the time of terminalization, in a step 504 the FFCs 10 are inserted into the cable opening(s) 122 of the connector assembly, and specifically, with the exposed conductors 12 thereof being positioned between the weld ends 181 of the terminals 180 and the partitioning wall 123 of the plug housing. Once inserted, in a step 506 the cable latches 140 are each biased from the first or open position shown in FIGS. 8 and 9, to the second or closed position shown in FIG. 1. This applies and maintains pressure between the weld area 183 of the terminal 180 and the conductor 12 of the FFC. In a step 508, inductive heating of the terminals/FFC conductors may be initiated by energizing a coil to desired parameters, which melts solder (e.g., solder tinned onto the weld areas 181 of the terminals 180 in a step 510. The melted solder transfers heat to the FFC conductors 12 to create a stable fully wetted solder joint. If necessary, induction coils could be arranged on each side of the connector assembly 100, or on only one side thereof as needed. During this step, surface tension and the wicking action of the solder should pull the solder from between the weld ends 181 of the terminals 180 to each joint. If some solder, does not pull from the between the terminals 180, the assembly 100 or processing fixture could be subject to slight vibration in a step 512 to promote all solder being attached to the terminals 180. In a step 514, heat from the soldering operation is sufficient to melt the adhesive hotmelt 150. Maintained pressure applied by the cable latches 140 bonds the weld ends 181 of the terminals 180, the conductors 12, and/or the insulation material 14 of the FFCs 10 with the hotmelt 150. This seals the resulting soldered joint and increases the pull out strength of the assembly 100. In a final step 518, the connector assembly 100 may be cooled by, for example, blown air to further ensure that the terminal is not heated to the point where stress relaxation occurs.

While the above embodiments of the present disclosure describe the use of inductive soldering techniques to join FFCs to terminals, it should be understood that other forms of soldering may be used with the terminals described herein. For example, resistance soldering techniques or brazing may be utilized without departing from the present disclosure. As would be understood by one of ordinary skill in the art, this technique would require access to each side of the joint, as well as the application of a meltable joining alloy between the elements to be joined (i.e., the terminals and the FFC conductors). Similarly, other techniques like laser soldering (e.g., so-called “BLUE” laser soldering) may offer distinct advantages in speed and accuracy over other soldering techniques, and typically results in a very small spot size and low solder usage.

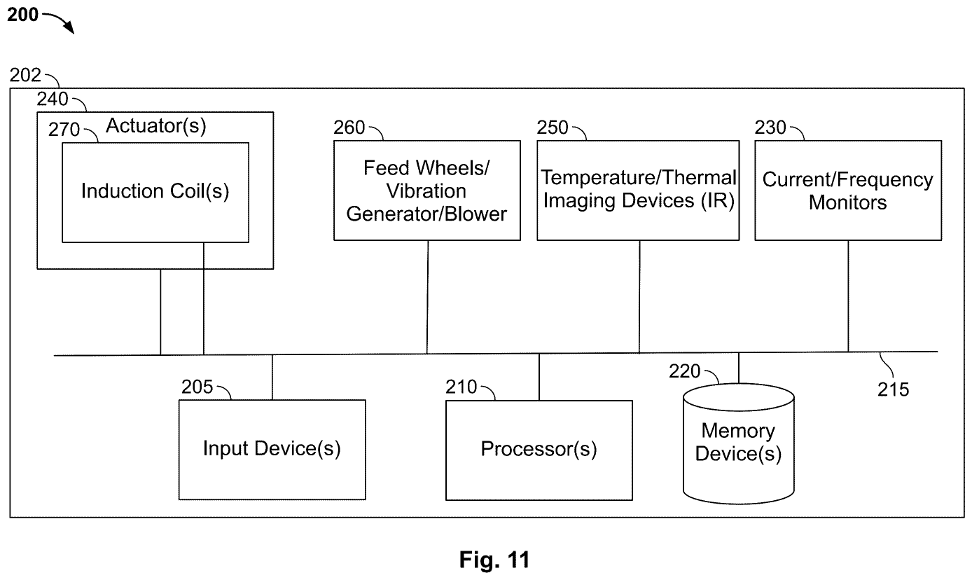

Soldering methods according to embodiments of the present disclosure may be carried out wholly or in part by one or more automated control systems implementing and/or controlling a soldering system or machine, as well as additional hardware and software features. For example, referring generally to FIG. 11, an exemplary control system 200 of a soldering system or machine 202 useful for performing the operations of the embodiments of the present disclosure is shown. The control system 200 may be under fully automated control, or fully or partially controlled via one or more user input devices 205 (e.g., touch screen/buttons/keyboards, etc.). The control system 200 includes at least one processor 210, such as a digital microprocessor responsive to instructions stored on a memory device 220 for performing the methods or operations described herein. The processor 210 is operatively coupled to the induction coil 270, and/or to a power supply thereof for selectively powering the coil under voltage and/or current control. The system 200 may further include a current and/or frequency monitor or sensor 230, which may be operative with the processor 210 to monitor and/or control the frequency and current in or through the induction coil 270.

The system 200, and more specifically the processor 210, may control the operation of feed wheels, vibration generator and/or blowers 260 of the machine 202 for selectively feeding the cable through the machine, vibrating the cable and connector assembly during soldering, and cooling the joint. Likewise, the control system 200 may comprise one or more actuators 240 (e.g., a linear actuator) operatively attached to the induction coil 270 for selectively moving the coil relative to the connector assembly being soldered. In one embodiment, the one or more actuators 240 may be multi-directional, having the ability to vary not only the longitudinal position of the induction coil 270 along a length of a connector assembly, but also the radial or lateral distance between the connector assembly and the induction coil, further promoting the ability to accurately control the generation of heat in predetermined areas of the assembly.

The control system 200 further comprises a temperature sensing device and/or imaging device, such as a thermal imaging device, and more specifically an infrared (IR) temperature sensor and/or camera 250, by way of example only. In other embodiments, the control system 200 may comprise separate temperature sensing devices and imaging devices. Further, the imaging device 250 may be optical, such as a digital camera or video capturing device without departing from the scope of the present disclosure. The thermal imaging device 250 may be mounted to the induction coil 270, or to another portion of the machine 202 suitable for achieving desired operation. As shown, each of the components of the control system 200 and/or the machine 202 may communicate over a shared power/data bus 215.

The control system 200, including the processor 210 operative with associated instructions pre-stored on the memory device 220, enables several additional modes of operations to those described above with respect to the proceeding figures. By way of example, using the current and/or frequency monitor 230, as well as predetermined values stored on the memory device 220, the processor 210 is operative to determine or estimate a characteristic, such as a size of the FFC conductors and/or the terminals, and automatically adjust various operating parameters according to this determination. The system 200 may vary heating times, periodic cycling parameters, frequency, voltage and/or current associated with the operation of the induction coil 270 according to a detected characteristic for achieving optimal operation. These parameters may be pre-stored in the memory device 220 such that, upon a determination by the processor 210 as to the relevant characteristics of the connector and/or FFC arrangement, the function of the coil 270 may be automatically controlled without the need for further user input.

According to embodiments, power is supplied to the induction coil 270 for a specified amount of time based on the application. The frequency of the induction coil 270 may be varied to control the depth of heating, for example, higher frequency allows the depth of the induction heating to be controlled such that the penetration of the induction heating is shallow. In contrast, a lower frequency allows induction heating to more deeply penetrate into the elements to be soldered.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A method of attaching at least one flat flexible cable (FFC) to a plurality of terminals, comprising:
arranging a plurality of terminals within a connector housing, each terminal defining a weld area adapted to be electrically connected to a conductor of the FFC;
positioning a first FFC (proximate the connector housing such that the weld area of each terminal is arranged directly adjacent a respective one of a plurality of exposed conductors of the first FFC;
fitting a first cable latch to the connector, the first cable latch including an adhesive hot melt material applied thereon;
clamping the weld areas of the terminals against the exposed conductors of the first FFC; and
heating at least the weld area of each of the plurality of terminals with an inductive heating source for electrically connecting the plurality of conductors of the first FFC to the plurality of terminals and melting the adhesive hot melt material.

2. The method of claim 1, wherein the step of fitting the first cable latch to the connector includes latching the first cable latch to the connector in a first position wherein the first cable latch does not contact the first FFC or the plurality of terminals.

3. The method of claim 2, wherein, prior to step of heating, the step of clamping the weld areas against the conductors includes biasing the first cable latch into a second position on the connector.

4. The method of claim 3, wherein the first cable latch is retained in the second position on the connector via engagement of latch arms of the first cable latch with corresponding first catches formed on the connector.

5. The method of claim 4, wherein the first cable latch is retained in the first position on the connector via engagement of the latch arms of the first cable latch with corresponding second catches formed on the connector.

6. The method of claim 1, wherein the step of positioning the first FFC includes inserting the first FFC into a first receiving space defined between a partitioning wall of the connector and an underside of a weld end of each of the terminals.

7. The method of claim 6, wherein the weld area is defined on the underside of the weld end of each terminal and opposes the exposed conductors of the first FFC positioned within the connector.

8. The method of claim 7, wherein the connector housing further includes:
a first row plurality of first openings defined on a first side of the partitioning wall and through which a first row of the terminals are arranged with the weld ends thereof opposing the partitioning wall; and
a second row of a plurality of second openings defined on a second side of the partitioning wall and through which a second row of the terminals (are arranged with the weld ends thereof opposing the partitioning wall.

9. The method of claim 8, further comprising the step of inserting a second FFC into a second receiving space defined between the partitioning wall of the connector and an underside of a weld end of each of the terminals arranged in the second row of the second openings.

10. The method of claim 9, further comprising the steps of:
fitting a second cable latch to the connector, the second cable latch including an adhesive hot melt material applied thereon; and
clamping weld areas of the terminals arranged in the second row of openings against exposed conductors of the second FFC with the second cable latch.

11. The method of claim 10, wherein the first cable latch and the second cable latch are biased in opposite directions toward the partitioning wall as they clamp the weld areas of the terminals to the first and second FFCs.

12. The method of claim 9, wherein the first and second receiving spaces each include guide protrusions formed therein and extending in a direction of insertion of each of the first and second FFCs, the guide protrusions sized and located to position the first and second FFCs between the partitioning wall and the respective weld ends of the terminals.
